(19) United States
(12) Patent Application Publication
(10) Pub. No.: US 2023/0046890 A1
(43) Pub. Date: Feb. 16, 2023

(54) Calendar Event Scheduling Artificial Intelligence Assistant using Natural Language

(71) Applicant: Paradox Inc., Scottsdale, AZ (US)

(72) Inventors: Stephen Derek Ost, Scottsdale, AZ (US); Cory Smith, Scottsdale, AZ (US); Jake Copeland, Scottsdale, AZ (US)

(73) Assignee: Paradox Inc., Scottsdale, AZ (US)

(21) Appl. No.: 17/817,145

(22) Filed: Aug. 3, 2022

Related U.S. Application Data
(60) Provisional application No. 63/260,112, filed on Aug. 10, 2021.

(51) Int. Cl. G06Q 10/10

(52) U.S. Cl. CPC G06Q 10/1095

(57) ABSTRACT

An intelligent assistant of a computing system receives a first message from a first client device. The computing system interfaces with calendar servers associated with electronic calendars associated with the possible attendees to retrieve calendar information for each possible attendee. The computing system analyzes the calendar information to identify a plurality of possible time slots for the calendar event. The computing system prompts the target user to select a time slot by sending the target user a message comprising the plurality of possible time slots. The computing system receives a selection of the time slot from the plurality of possible time slots from the target user via a reply message. The computing system identifies a subset of possible attendees associated with the time slot. The computing system, in real-time, schedules the calendar event comprising the target user and the subset of possible attendees.

### CROSS-REFERENCE TO RELATED APPLICATIONS

This application claims priority to U.S. Provisional Application Serial No. 63/260,112 filed Aug. 10, 2021, which is hereby incorporated by reference in its entirety.

### FIELD OF THE DISCLOSURE

Embodiments disclosed herein generally related to a calendar event scheduling system and, more particularly, a calendar event scheduling system utilizing an artificial intelligence assistant.

### BACKGROUND

Scheduling calendar events, including meetings and interviews, with potential attendees is a time-consuming process. Any time a user or system has to interface with multiple potential attendees, the user or system would have to establish multiple lines of dialogue to coordinate schedules and determine an optimal or preferred date and time for the calendar event. In situations where the calendar event is complex and includes several meetings or attendees, this problem grows in complexity.

### SUMMARY

In some embodiments, a method is disclosed herein. An intelligent assistant of a computing system receives a first message from a first client device. The first message includes a request to schedule a calendar event with a target user. The computing system identifies possible attendees for the calendar event based on the request. The computing system interfaces with calendar servers associated with electronic calendars associated with the possible attendees to retrieve calendar information for each possible attendee. The computing system analyzes the calendar information for each possible attendee to identify a plurality of possible time slots for the calendar event. The computing system prompts the target user to select a time slot from the plurality of possible time slots by sending the target user a message that includes the plurality of possible time slots. The computing system receives a selection of the time slot from the plurality of possible time slots from the target user via a reply message sent from the target user to the intelligent assistant of the computing system. The computing system identifies a subset of possible attendees associated with the time slot. Based on the receiving and identifying, the computing system schedules, in real-time, the calendar event that includes the target user and the subset of possible attendees.

In some embodiments, a method is disclosed herein. An intelligent assistant of a computing system receives a first message from a first client device. The first message includes a request to schedule a calendar event with a candidate. The computing system identifies multiple attendees for the calendar event based on the request. The computing system interfaces with calendar servers associated with electronic calendars associated with the multiple attendees to retrieve calendar information for each attendee. The computing system determines that there is no common availability among the multiple attendees based on the calendar information. The computing system determines that a single attendee does not have common availability with remaining attendees of the multiple attendees. The computing system compiles shared availability among the remaining attendees into a list. The computing system prompts the single attendee to select a time from the list by sending the single attendee a message that includes the shared availability. The computing system receives a selection of a time for the calendar event from the list a reply message sent from the single attendee to the intelligent assistant of the computing system. Based on the selection, the computing system schedules, in real-time, the calendar event for the selected time, the calendar event that includes the multiple attendees and the candidate.

In some embodiments, a method is disclosed herein. An intelligent assistant of a computing system receives a first message from a first client device. The first message includes a request to schedule a calendar event with a candidate. The computing system identifies multiple attendees for the calendar event based on the request. The computing system interfaces with calendar servers associated with electronic calendars associated with the multiple attendees to retrieve calendar information for each attendee. The computing system determines that there is no common availability among the multiple attendees based on the calendar information. Based on the determining, the computing system reviews historic calendar information associated with the multiple attendees to learn when the multiple attendees have been previously available as a group. The computing system compiles available times of the multiple attendees with the historic calendar information. The computing system prompts the multiple attendees to select a set of times from the available times of the multiple attendees. The computing system receives a plurality of responses from the multiple attendees. The computing system analyzes the plurality of responses to identify an available time that is common among the multiple attendees. Based on the analyzing, the computing system schedules, in real-time, the calendar event for the available time, the calendar event that includes the multiple attendees and the candidate.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 is a block diagram illustrating a computing environment, according to example embodiments.

FIG. 2 is a block diagram illustrating communication among components of the computing environment of FIG. 1, according to example embodiments.

FIG. 3 is a flow diagram illustrating a method of facilitating a calendar event scheduling process, according to example embodiments.

FIG. 4 is a flow diagram illustrating a method of performing a calendar negotiation process, according to example embodiments

FIG. 5 is a flow diagram illustrating a method of performing a calendar negotiation process, according to example embodiments

FIG. 6 is a flow diagram illustrating a method of scheduling multiple calendar events, according to example embodiments.

FIG. 7A illustrates a system bus computing system architecture, according to example embodiments.

FIG. 7B illustrates a computer system having a chipset architecture, according to example embodiments.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

Most calendar events today are scheduled with humans coordinating the process. Over time, conventional software has been developed to facilitate some form of automation in the calendar event scheduling process. However, such conventional software faces significant challenges in that users need to directly interface with attendees and internal reviewers throughout the process to ensure timeliness of the calendar event. As such, despite marketing itself as a form of automated technology, these conventional systems still require frequent human intervention throughout the process.

One or more techniques described herein provide an improvement over conventional approaches to scheduling software by addressing scalability and usability challenges faced in the calendar event scheduling process. For example, one or more embodiments provided herein may utilize natural language process and natural language understanding techniques to facilitate the scheduling of calendar events (e.g., interviews, meetings, lunches, etc.). Such approach does not require additional user training and instead allows users to converse with an artificial intelligence assistant, in natural language, for a calendar event scheduling process in real-time. For example, to express that a currently scheduled calendar event may need to be rescheduled, a user can simply reply to a message with a phrase in natural language, such as: “Hey, I'm really sorry, but I now have a conflict for the calendar event on Tuesday.”

In some embodiments, the one or more techniques may also address the problem of scheduling complicated calendar event sequences. For example, scheduling a full day of calendar events for a candidate with many attendees can become very complicated for a user to schedule. The user would need to compare schedules of each attendee individually to find overlapping times that work for everyone involved. If, after scheduling, the user needs their attendees to change their schedules around, the user must reach out individually to each attendee to accommodate this change. The present approach eliminates this time-consuming process by comparing calendar information for each attendee and automating communication with the attendees using natural language to move schedules around and, ultimately, identify the best opportunities for these highly complex calendar event schedules, which are then communicated in natural language and rescheduled, in real-time, with minimal participation from attendees.

While the below discussion mentions a message or messages being passed or sent between computing devices, those skilled in the art that a message may refer to messages through various communication channels. For example, a message may refer to an email, a text message (e.g., SMS, iMessage, WhatsApp, Facebook Messenger, etc.), a voice message, and the like.

The term “user” as used herein includes, for example, a person or entity that owns a computing device or wireless device; a person or entity that operates or utilizes a computing device or wireless device; or a person or entity that is otherwise associated with a computing device or wireless device. It is contemplated that the term “user” is not intended to be limiting and may include various examples beyond those described.

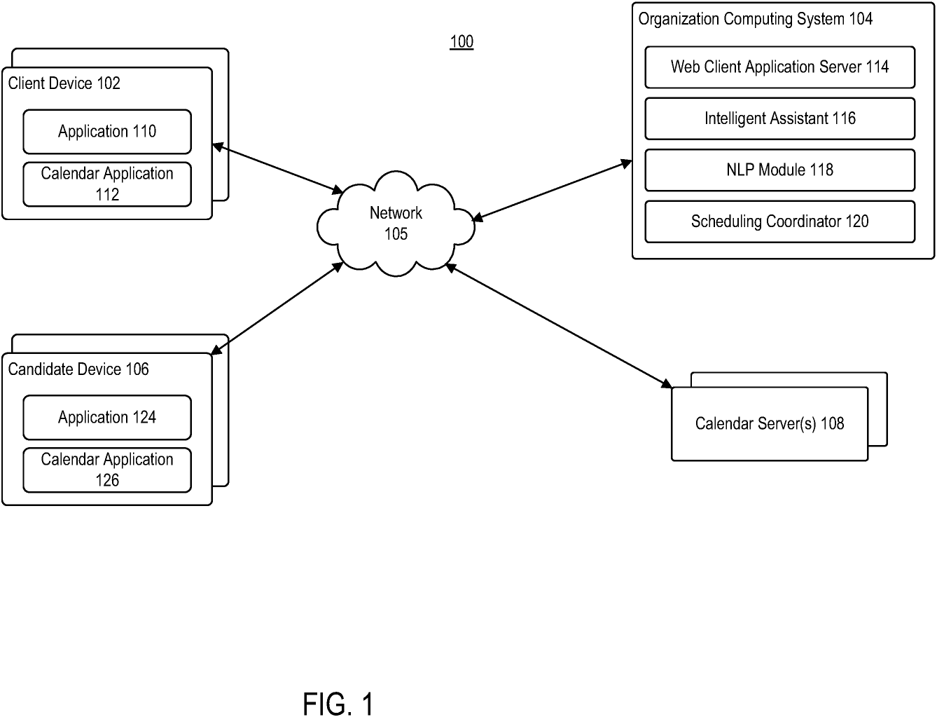

FIG. 1 is a block diagram illustrating computing environment 100, according to example embodiments. Computing environment 100 may include at least one or more client devices 102, a back-end computing system 104, one or more candidate devices 106, and one or more calendar servers 108 communicating via network 105.

Network 105 may be of any suitable type, including individual connections via the Internet, such as cellular or Wi-Fi networks. In some embodiments, network 105 may connect terminals, services, and mobile devices using direct connections, such as radio frequency identification (RFID), near-field communication (NFC), Bluetooth™, low-energy Bluetooth™ (BLE), Wi-Fi™, ZigBee™, ambient backscatter communication (ABC) protocols, USB, WAN, or LAN. Because the information transmitted may be personal or confidential, security concerns may dictate one or more of these types of connection be encrypted or otherwise secured. In some embodiments, however, the information being transmitted may be less personal, and therefore, the network connections may be selected for convenience over security.

Network 105 may include any type of computer networking arrangement used to exchange data. For example, network 105 may be the Internet, a private data network, virtual private network using a public network and/or other suitable connection(s) that enables components in computing environment 100 to send and receive information between the components of computing environment 100.

Client device 102 may be operated by a user. For example, client device 102 may be a mobile device, a tablet, a desktop computer, or any computing system having the capabilities described herein. Client device 102 may belong to or be provided to a member of an organization accessing functionality of back-end computing system 104. For example, client device 102 may belong to an organization or company that may be leveraging functionality of back-end computing system 104 for scheduling a calendar event for a candidate. In some embodiments, a user of client device 102 may be referred to as an “attendee” or “employee.”

Client device 102 may include at least application 110 and calendar application 112. In some embodiments, application 110 may be a standalone application associated with back-end computing system 104. In some embodiments, application 110 may be representative of a web browser that allows access to a website associated with back-end computing system 104. Client device 102 may access application 110 to access scheduling functionality associated with back-end computing system 104. In some embodiments, client device 102 may communicate over network 105 to request a webpage, for example, from web client application server 114. For example, client device 102 may be configured to execute application 110 to access content managed by web client application server 114. The content that is displayed to client device 102 may be transmitted from web client application server 114 to client device 102, and subsequently processed by application 110 for display through a graphical user interface (GUI) of client device 102.

Calendar application 112 may be representative of an application that manages appointments and/or meetings for the user. In some embodiments, calendar application 112 may be representative of a much broader e-mail client that includes calendaring functionality, such as, but not limited to, Microsoft Outlook, Google Gmail, and the like. Generally, calendar application 112 may store or manage the user’s calendar. As such, calendar application 112 may maintain various time slots for the user, including, but not limited to, available time slots and unavailable time slots.

Candidate device 106 may be operated by a user. For example, candidate device 106 may be a mobile device, a tablet, a desktop computer, or any computing system having the capabilities described herein. Candidate device 106 may belong to or be provided to a user or candidate seeking a job or position with an organization associated with back-end computing system 104. For example, candidate device 106 may belong to a candidate that has applied to an open job position and is interacting with back-end computing system 104 for scheduling a calendar event for the job opening. In some embodiments, a user of client device 102 may be referred to as a “candidate.”

Candidate device 106 may include at least application 124 and calendar application 126. In some embodiments, application 124 may be a standalone application associated with back-end computing system 104. In some embodiments, application 124 may be representative of a web browser that allows access to a website associated with back-end computing system 104. Candidate device 106 may access application 124 to access scheduling functionality associated with back-end computing system 104. In some embodiments, candidate device 106 may communicate over network 105 to request a webpage, for example, from web client application server 114. For example, candidate device 106 may be configured to execute application 124 to access content managed by web client application server 114. The content that is displayed to candidate device 106 may be transmitted from web client application server 114 to candidate device 106, and subsequently processed by application 124 for display through a graphical user interface (GUI) of candidate device 106.

Calendar application 126 may be representative of an application that manages appointments and/or meetings for the candidate. In some embodiments, calendar application 126 may be representative of a much broader e-mail client that includes calendaring functionality, such as, but not limited to, Microsoft Outlook, Google Gmail, and the like. Generally, calendar application 126 may store or manage the candidate’s calendar. As such, calendar application 126 may maintain various time slots for the candidate, including, but not limited to, available time slots and unavailable time slots.

Back-end computing system 104 may include web client application server 114, intelligent assistant 116, natural language processing (NLP) module 118, and scheduling coordinator 120. Each of intelligent assistant 116, NLP module 118, and scheduling coordinator 120 may be comprised of one or more software modules. The one or more software modules may be collections of code or instructions stored on a media (e.g., memory of back-end computing system 104) that represent a series of machine instructions (e.g., program code) that implements one or more algorithmic steps. Such machine instructions may be the actual computer code the processor of back-end computing system 104 interprets to implement the instructions or, alternatively, may be a higher level of coding of the instructions that is interpreted to obtain the actual computer code. The one or more software modules may also include one or more hardware components. One or more aspects of an example algorithm may be performed by the hardware components (e.g., circuitry) itself, rather than as a result of instructions.

Scheduling coordinator 120 may be configured to schedule a meeting with a candidate for a job opening. For example, scheduling coordinator 120 may facilitate or help facilitate a user of client device 102 schedule a calendar event or a plurality of calendar events for a candidate. In some embodiments, scheduling coordinator 120 may provide an interface, accessible to the user via client device 102, in which the user can set the parameters for a calendar event. For example, scheduling coordinator 120 may provide a user with a list of job openings and a list of candidates for each job. The user may request a calendar event with any of the candidates for any of the job openings. Using a specific example, the user may request a calendar event for an interview of John Doe for the job opening of Corporate Associate. In some embodiments, such as when the calendar event is for an interview or meeting, the calendar event request may include one or more of a calendar event type (e.g., in-person, phone, virtual, etc.), calendar event duration, attendees (e.g., interviewers), preparation documents, and notes.

As provided above, via scheduling coordinator 120, a user may select those members of the organization that should attend the calendar event. For example, the user may select User 1, User 2, and User 3 to attend the calendar event. To schedule the calendar event or calendar events, in some embodiments, scheduling coordinator 120 may interface with one or more calendar servers 108. By interfacing with one or more calendar servers 108, scheduling coordinator 120 may retrieve or pull calendar data for each user from their respective calendar to generate a combined or aggregated calendar. In this manner, scheduling coordinator 120 may automatically identify time available slots for potential attendees, and intelligently schedule a slate of calendar event in real-time.

In some embodiments, rather than a user providing scheduling coordinator 120 with specific users for scheduling a calendar event, the user may provide scheduling coordinator 120 with groups of candidates for scheduling coordinator 120 to intelligently schedule one or more calendar events. This may be referred to as “round robin” of calendar events. For example, the user scheduling the calendar event may specify, with the calendar event request, that the calendar event should include one person from a first group (e.g., sales) and one person from a second group (e.g., marketing) to attend. Scheduling coordinator 120 may generate a round robin group for the first group (e.g., sales) that may include more than one individual. Scheduling coordinator 120 may generate a second round robin group for the second group (e.g., marketing) that may include more than one individual. Scheduling coordinator 120 may analyze all user calendars and combine them into one temporary calendar to identify available time slots. Scheduling coordinator 120 may provide the available time slots to the candidate. When a candidate selects a time, including by use of natural language, scheduling coordinator 120 may, in turn, identify those attendees that have this time available. Scheduling coordinator 120 may then select an attendee or attendees to join, based on different factors (e.g., the attendee with the least amount of currently scheduled calendar events) in real-time. In this manner, scheduling coordinator 120 may combine logic of soonest available with load balancing functionality. In conventional systems, a scheduling user will need to select whether they want a calendar event to be soonest available or distributed evenly. Conventional systems are unable to replicate the above functionality.

Although shown as separate components, scheduling coordinator 120 may either be leveraged by or integrated with intelligent assistant 116. Intelligent assistant 116 may enable a user to set up and organize calendar events for an opening using natural language. For example, rather than interfacing with back-end computing system 104 via a native application or web browser, a user of client device 102 may send messages to intelligent assistant 116 using a messaging application. Using a specific example, a user of client device 102 may use short message service (SMS) texting, rich communication service (RCS) texting, multi-media service (MMS) messaging, instant messaging, iMessage texting, Facebook Messenger, Google Messages, extensible messaging and present protocol (XMPP) messaging (e.g., WhatsApp), and the like to communicate with intelligent assistant 116. In this manner, a user could message intelligent assistant 116: “Please set up a calendar event for the Corporate Associate position with John Doe.” Responsive to receiving this message, intelligent assistant 116 may work with scheduling coordinator 120 to schedule a calendar event with John Doe. In another example, "Set up three calendar events with John Doe for the Corporate Associate position. Make sure each calendar event includes an associate and a partner." Responsive to receiving this message, intelligent assistant 116 may work with scheduling coordinator 120 to schedule three calendar events with John Doe using, for example, round robin techniques, in real-time.

In addition to initiating or setting up a calendar event, intelligent assistant 116 may further support communications from various users of client devices 102 and candidates of candidate devices 106. For example, once intelligent assistant 116 identifies possible times for a meeting, intelligent assistant 116 may present selected times to the candidate over a range of dates/times via various communication channels. In some embodiments, intelligent assistant 116 may receive an indication that the candidate cannot make any of the proposed times. For example, candidate device 106 may prompt intelligent assistant 116 to provide additional dates and times if the initially presented times do not accommodate their schedule. In some embodiments, this process may be performed through natural language messaging. For example, candidate device 106 may send to intelligent assistant 116 a message that includes: "None of those times work for me. Do u have any other times available?" The candidate may select a time through natural language as well. For example, candidate device 106 may send to intelligent assistant 116 a message that includes: “Let’s do 130pm on Tuesday.” In this manner, intelligent assistant 116 may work with scheduling coordinator 120 to schedule a calendar event with a candidate using natural language messaging.

In some embodiments, it may be difficult for intelligent assistant 116 to identify time slots for attendees. If there, for example, there is no common availability among potential attendees and the candidate, intelligent assistant 116 may reach out to attendees to request that they add more availability to their calendars. In some embodiments, intelligent assistant 116 may take a more proactive approach by analyzing each attendee’s calendar to identify times with the fewest conflicts. Intelligent assistant 116 may chat directly with each attendee that may have conflicts to see if those times would work for them. Such approach may decrease the amount of back-and-forth that intelligent assistant 116 may have with users, thus decreasing the overall time to schedule the calendar events.

In some embodiments, scheduling coordinator 120 may be configured to perform a calendar negotiation process. For example, scheduling coordinator 120 may be trained on historic user data to coordinate schedules of all calendar event attendees. Such functionality may allow, for example, recruiters and coordinators to remove themselves from the scheduling process, thus eliminating the need for them to reach out to all parties to find availabilities.

In some embodiments, scheduling coordinator 120 may conduct a calendar negotiation process that may involve a single individual or a single party to a potential calendar event that may be unable to match the availability of the other interviews. In some embodiments, the user may be an interviewer. In some embodiments, the user may be a candidate. In such embodiments, intelligent assistant 116 may be configured to engage that user to see if they are available when the other parties to the potential calendar event are available. scheduling coordinator 120 may be configured to generate a list of times that all of the other parties for the potential calendar event are available to take place. Intelligent assistant 116 may prompt the user to select which time or times could work best for them. If the user responds, intelligent assistant 116 may utilize natural language processing to understand the user’s choice or choices and may add those times as available for this specific potential calendar event. Once there is shared availability among the parties, intelligent assistant 116 may resume one or more processes that may include communicating with a candidate to offer times and confirm the calendar event.

In some embodiments, scheduling coordinator 120 may conduct a calendar negotiation process that may involve multiple users in a multi-person interview that may not have shared availability. In such situations, scheduling coordinator 120, via intelligent assistant 116, may notify all users designated for the calendar event that more availability needs to be added. During such process, intelligent assistant 116 may provide the users with a full readout of the availabilities of all users to understand when times would be best for the entire group. In some embodiments, scheduling coordinator 120 may be further configured to review historical data from the calendars of each respective user to see when the users have been available as a group over a given period of time (e.g., past week, past month, past quarter, etc.). In some embodiments, users may be able to self-elect additional times that they may be available. After shared availability is added, scheduling coordinator 120 may be configured to schedule the calendar event with the candidate.

In some embodiments, a user may attempt to schedule multiple interviews at a time (e.g., a sequential interview). In such embodiments, scheduling coordinator 120 may be configured to schedule the interview using one or more techniques: in consecutive order, in any consecutive order, or over multiple days. For in consecutive order, scheduling coordinator 120 may be configured if there is sufficient time available for the original order of interviews. For example, if the user specified that the candidate should meet with Person A, Person B, and Person C, scheduling coordinator 120 may try to schedule the multiple interviews in the order: Person A, Person B, and Person C. If there is not enough time for the original order of interviews, scheduling coordinator 120 may determine whether there is sufficient availability for any consecutive order involving Person A, Person B, and Person C. If there is not enough time for any consecutive order involving Person A, Person B, and Person C, scheduling coordinator 120 may determine that the interviews would need to be scheduled over multiple days. In such circumstances, intelligent assistant 116 may notify the users of the changes that may be made, and may allow each party to either accept or revert the change.

Once the candidate selects a proposed time, intelligent assistant 116 may continue to interact or engage with the candidate up to the calendar event. In some embodiments, intelligent assistant 116 may send out calendar invitations or information regarding the calendar event to attendees (e.g., client devices 102) and the candidate (e.g., candidate device 106). In some embodiments, the calendar invitations may include preparation documents attached thereto. Further, assuming the candidate has accepted the calendar invitation, intelligent assistant 116 may be programmed to follow up with candidates with reminders or confirmation requests leading up to the calendar event. For example, intelligent assistant 116 may routinely remind the candidate of an upcoming calendar event.

In some embodiments, intelligent assistant 116 may further facilitate the actual calendar event itself. For example, in some embodiments, intelligent assistant 116 may interface with a video conferencing application to generate links for a scheduled video conference. In some embodiments, intelligent assistant 116 may be a participant to the calendar event, such as an intelligent interviewer or attendee for an interview. For example, intelligent assistant 116 may be the entity that is performing the interview of the candidate.

As those skilled in the art recognize, in some embodiments, an attendee or candidate may no longer be able to make the scheduled calendar event. In some embodiments, intelligent assistant 116 may handle reschedule or cancellation requests. For example, an attendee or candidate may message intelligent assistant 116, using natural language, requesting that a calendar event be rescheduled or cancelled. Intelligent assistant 116 may work with scheduling coordinator 120 to identify proposed new times and new possible attendees for a new calendar event date with the candidate. In those situations where the user has cancelled the calendar event, intelligent assistant 116 may facilitate notifying attendees of the cancellation. In some embodiments, intelligent assistant 116 may send a calendar invitation update, notifying the attendees that the calendar event was cancelled. In some embodiments, intelligent assistant 116 may message users, using natural language, that the calendar event was cancelled. In this manner, intelligent assistant 116 may continually engage with the candidate and/or attendees to ensure smooth management of their calendar events.

Further, if the candidate has any questions leading up to the calendar event, the candidate may message intelligent assistant 116. For example, the candidate may send intelligent assistant 116 a message asking: “What is the dress code for tomorrow?” or “Is there parking on-site?” to which the intelligent assistant may respond, in natural language, and provide responses to the questions asked, to facilitate a smooth pre-calendar event process.

Still further, following the calendar event, intelligent assistant 116 may prompt attendees to review or rate the candidate. For example, intelligent assistant 116 may prompt each attendee to send a natural language message rating the candidate or providing feedback on the candidate. Intelligent assistant 116 may generate a report that includes the aggregate ratings and/or feedback. In addition, following the calendar event, intelligent assistant 116 may prompt the candidate to review or rate the calendar event process using natural language messaging.

NLP module 118 may be configured to analyze documents provide by candidate device 106 during the intake process. For example, in some calendar events, intelligent assistant 116 may request certain documentation from a candidate. Exemplary documentation may include, but is not limited to, a resume, writing sample, presentations, and the like. In some embodiments, the candidate may upload such documents via application 110 executing thereon. In some embodiments, the candidate may send the documents to intelligent assistant 116 through various communication channels, such as, but not limited to, text messaging, email, voice, and the like. For example, the candidate may attach the documents to a text message sent to intelligent assistant 116. NLP module 118 may be configured to analyze and process documents uploaded by an end user. NLP module 118 may be configured to extract information that may be relevant to attendees of the calendar event. For example, NLP module 118 may extract information directed to: employment history, education history, job skills, keywords, and the like. Intelligent assistant 116 may provide the extracted information to attendees as preparation documents for the calendar event.

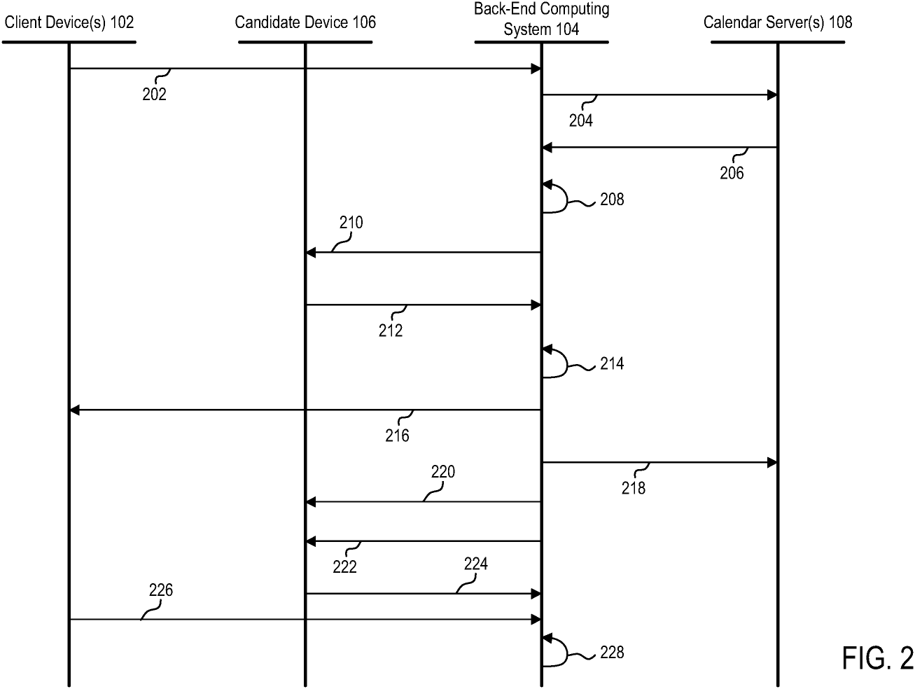

FIG. 2 is a block diagram illustrating communications among components of computing environment 100, according to example embodiments.

As shown, at block 202, the calendar event scheduling process may be initiated by at least one client device 102. For example, a lead client device 102 may request that a calendar event be scheduled with a candidate for a job opening. In some embodiments, lead client device 102 may request that the calendar event be scheduled via application 110 executing thereon. For example, a user of lead client device 102 may interact with a graphical user interface to select a candidate for which calendar events are to be scheduled. In some embodiments, lead client device 102 may request that the calendar event be scheduled via a text message. For example, lead client device 102 may send a message to intelligent assistant 116 requesting that a calendar event be scheduled with the candidate for the job opening.

At block 204, back-end computing system 104 may request calendar information from one or more calendar servers 108. For example, scheduling coordinator 120 may interface with one or more calendar servers 108 to pull or retrieve calendar data related to a plurality of possible attendees for the calendar event or calendar event s with the candidate.

At block 206, calendar servers 108 may receive the request for calendar information from scheduling coordinator 120. In response, calendar servers 108 may transmit the calendar data or allow scheduling coordinator 120 to pull said data from calendar servers 108. In some embodiments, such request may be received by multiple calendar servers. For example, scheduling coordinator 120 may interface or communicate with a first calendar server 108 corresponding to Outlook and a second calendar server 108 corresponding to Google Calendar.

At block 208, back-end computing system 104 may generate a list of proposed times to provide to the candidate based on the calendar information. To do so, scheduling coordinator 120 may generate a combined or aggregated calendar based on the calendar information pulled or retrieved from calendar servers 108. Using the aggregated calendar, scheduling coordinator 120 may automatically identify time available slots for potential attendees, and intelligently schedule one or more calendar events with the candidate in real-time.

In some embodiments, such as when multiple calendar events are requested with the candidate, scheduling coordinator 120 may be configured to optimize the calendar events with respect to the candidate and the possible attendees. For example, the user scheduling the calendar event may specify, with the calendar event request, that a calendar event should include one person from a first group (e.g., sales) and one person from a second group (e.g., marketing) to attend. Scheduling coordinator 120 may generate a round robin group for the first group (e.g., sales) that may include more than one individual. Scheduling coordinator 120 may generate a second round robin group for the second group (e.g., marketing) that may include more than one individual. Scheduling coordinator 120 may analyze all user calendars and combine them into one temporary calendar to identify available time slots.

Although not shown, in some embodiments, scheduling coordinator 120 may not be able to identify overlapping time slots. To further expedite the process, intelligent assistant 116 may communicate with potential attendees, via client devices 102, to request that the attendees make more time available on their calendars. In such embodiments, scheduling coordinator 120 may continually or periodically request calendar information updates from calendar servers 108, so that scheduling coordinator 120 may update the aggregated calendar and identify new potential time slots.

At block 210, back-end computing system 104 may provide candidate device 106 with a list of potential calendar event times. In some embodiments, back-end computing system 104 may provide candidate device 106 with the list of potential calendar event times via application 124 executing on candidate device 106. For example, back-end computing system 104 may push a notification for a candidate to select calendar event times via an interface presented via application 124. In some embodiments, back-end computing system 104 may provide candidate device 106 with the list of potential calendar event times via intelligent assistant 116. For example, intelligent assistant 116 may send a text message to candidate device 106 that includes a listing of potential calendar event times for the candidate to select from.

At block 212, candidate device 106 may provide back-end computing system 104 with a selection of a time slot or time slots for calendar events. In some embodiments, candidate device 106 may provide the candidate’s response via application 124 executing thereon. In some embodiments, candidate device 106 may provide the candidate’s response in natural language by sending a text message to intelligent assistant 116. For example, the message may recite: “The time slots on Wednesday work” or “Let’s do Friday @ 10.”

At block 214, back-end computing system 104 may receive the response from the user. When the candidate selects a time, scheduling coordinator 120 may, in turn, identify those attendees that have this time available. Scheduling coordinator 120 may then select an attendee or attendees to join with the least amount of current scheduled calendar events. In this manner, scheduling coordinator 120 may combine logic of soonest available with load balancing functionality.

At block 216, back-end computing system 104 may identify those attendees that have open time slots corresponding to the candidate’s selected times. In some embodiments, back-end computing system 104 may provide each respective client device 102 with the indication or notification via application 110 executing on each client device 102. For example, back-end computing system 104 may push a notification to the attendee’s client device 102, notifying the attendee that they are scheduled for a calendar event with the candidate. In some embodiments, back-end computing system 104 may provide each attendee’s client device 102 with the notification via a message sent by intelligent assistant 116. For example, intelligent assistant 116 may send a text message to each respective client device 102 with an indication they have been scheduled for a calendar event with the candidate at a respective time and date.

At block 218, back-end computing system 104 may also request interface with respective calendar servers 108 to add a calendar entry to each scheduled attendee’s calendar. In this manner, scheduling coordinator 120 may generate in real-time a calendar entry for each attendee’s respective calendar event time.

In some embodiments, back-end computing system 104 may also confirm the calendar event with the candidate. For example, at block 220, back-end computing system 104 may confirm the calendar events with candidate device 106. In some embodiments, back-end computing system 104 may confirm the calendar events with candidate device 106 via application 124 executing on candidate device 106. For example, back-end computing system 104 may push a confirmation notification to candidate device 106 via application 124. In some embodiments, back-end computing system 104 may provide candidate device 106 with a confirmation message via intelligent assistant 116. For example, intelligent assistant 116 may send a text message to candidate device 106 that includes a confirmation message of the dates and times of the calendar events.

In some embodiments, back-end computing system 104 may periodically send reminders to the candidate and attendees. For example, at block 222, back-end computing system 104 may send a calendar event reminder to candidate device 106. In some embodiments, back-end computing system 104 may send the calendar event reminder to candidate device 106 via application 124 executing on candidate device 106. For example, back-end computing system 104 may push a calendar event reminder to candidate device 106 via application 124. In some embodiments, back-end computing system 104 may provide candidate device 106 with a calendar event reminder via intelligent assistant 116. For example, intelligent assistant 116 may send a text message to candidate device 106 that includes a message reminding the candidate of the dates and times of the calendar events.

As those skilled in the art recognize, in some embodiments, the candidate or an attendee may need to cancel or reschedule their respective calendar event. For example, at block 224, candidate device 106 may notify back-end computing system 104 that they need to reschedule or cancel their calendar event using natural language. In some embodiments, the cancellation or rescheduling request may be initiated via application 124. In some embodiments, the cancellation or rescheduling request may be initiated via a text message to intelligent assistant 116.

Similarly, at block 226, a client device 102 may notify back-end computing system 104 that the attendee needs to reschedule or cancel their calendar event. In some embodiments, the cancellation or rescheduling request may be initiated via application 110. In some embodiments, the cancellation or rescheduling request may be initiated via a text message to intelligent assistant 116 using natural language.

In both cases, at block 228, back-end computing system 104 may repeat the operations at blocks 204-212 to reschedule the calendar event or calendar events.

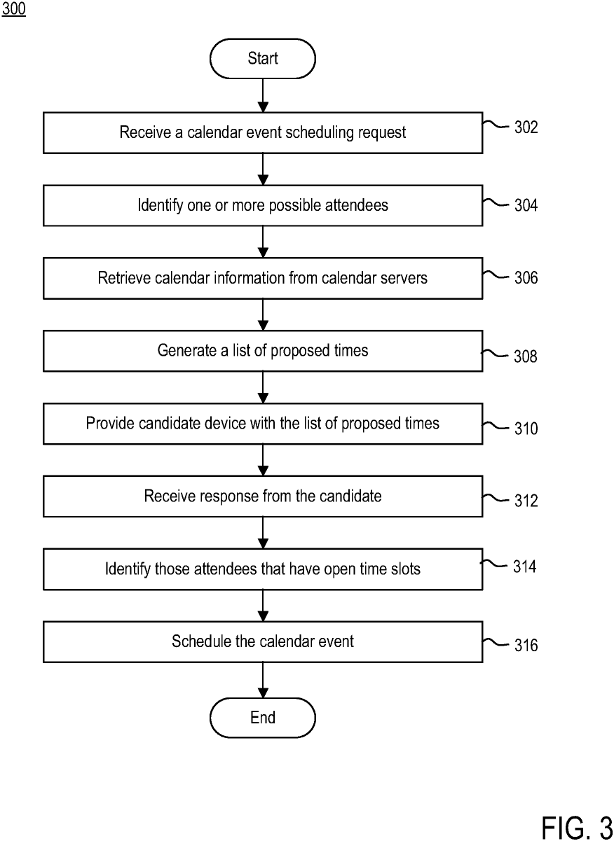

FIG. 3 is a flow diagram illustrating a method 300 of facilitating a calendar event scheduling process, according to example embodiments. Method 300 may begin at step 302.

At step 302, back-end computing system 104 may receive a calendar event scheduling request from a client device 102 (e.g., a lead client device 102). In some embodiments, back-end computing system 104 may receive calendar event scheduling request via application 110 executing on client device 102. In some embodiments, back-end computing system 104 may receive a calendar event scheduling request via a message sent to intelligent assistant 116. In some embodiments, the calendar event scheduling request may include one or more parameters associated therewith. For example, the calendar event scheduling request may include one or more of the job opening, the candidate for the calendar event, calendar event duration, attendees (e.g., interviewers), preparation documents, notes, and the like.

At step 304, back-end computing system 104 may identify one or more possible attendees for the calendar event based on the calendar event scheduling request. In some embodiments, the one or more possible attendees may be specified, by name, in the calendar event request. In some embodiments, one or more possible groups of attendees may be specified in the calendar event request. For example, lead client device 102 may only specify that there should be at least one person from a first group (e.g., sales) and at least one person from a second group (e.g., marketing) in each calendar event time slot. In some embodiments, the attendees are not specified, and scheduling coordinator 120 may default to a predefined list of attendees.

At step 306, back-end computing system 104 may retrieve calendar information from one or more calendar servers 108. For example, scheduling coordinator 120 may interface with one or more calendar servers 108 to pull or retrieve calendar data related to a plurality of possible attendees for the calendar event or calendar events with the candidate.

At step 308, back-end computing system 104 may generate a list of proposed times to provide to the candidate based on the calendar information. To do so, scheduling coordinator 120 may generate a combined or aggregated calendar based on the calendar information pulled or retrieved from calendar servers 108. Using the aggregated calendar, scheduling coordinator 120 may automatically identify time available slots for potential attendees, and intelligently schedule one or more calendar events with the candidate in real-time.

In some embodiments, such as when multiple calendar events are requested with the candidate, scheduling coordinator 120 may be configured to optimize the set of calendar events with respect to the candidate and the possible attendees. For example, the user requesting the calendar event may specify, with the calendar event request, that the calendar event should include one person from a first group (e.g., sales) and one person from a second group (e.g., marketing) to attend. Scheduling coordinator 120 may analyze all user calendars and combine them into one temporary calendar to identify available time slots.

At step 310, back-end computing system 104 may provide candidate device 106 with a list of potential calendar event times. In some embodiments, back-end computing system 104 may provide candidate device 106 with the list of potential calendar event times via application 124 executing on candidate device 106. For example, back-end computing system 104 may push a notification for a candidate to select calendar event times via an interface presented via application 124. In some embodiments, back-end computing system 104 may provide candidate device 106 with the list of potential calendar event times via intelligent assistant 116. For example, intelligent assistant 116 may send a text message to candidate device 106 that includes a listing of potential calendar event times for the candidate to select from.

At step 312, back-end computing system 104 may receive the response from the candidate. For example, the response may indicate which slot, of the available time slots, the candidate chose for their calendar event(s). In some embodiments, back-end computing system 104 may receive the response via application 124 executing on candidate device 106 in natural language. In some embodiments, back-end computing system 104 may receive the response via a text message provided to intelligent assistant 116 in natural language.

At step 314, back-end computing system 104 may identify those attendees that have open time slots corresponding to the candidate’s selected times and notify them that they are scheduled for a calendar event. In some embodiments, back-end computing system 104 may provide each respective client device 102 with the indication or notification via application 110 executing on each client device 102. For example, back-end computing system 104 may push a notification to the attendee’s client device 102, notifying the attendee that they are scheduled for a calendar event with the candidate. In some embodiments, back-end computing system 104 may provide each attendee’s client device 102 with the notification via a message sent by intelligent assistant 116. For example, intelligent assistant 116 may send a text message to each respective client device 102 with an indication they have been scheduled for a calendar event with the candidate at a respective time and date.

At step 316, back-end computing system 104 may schedule a calendar event with the identified attendees and the candidate in real-time. In some embodiments, scheduling the calendar event may include pushing a calendar invite to each attendee’s client device 102 and candidate device 106.

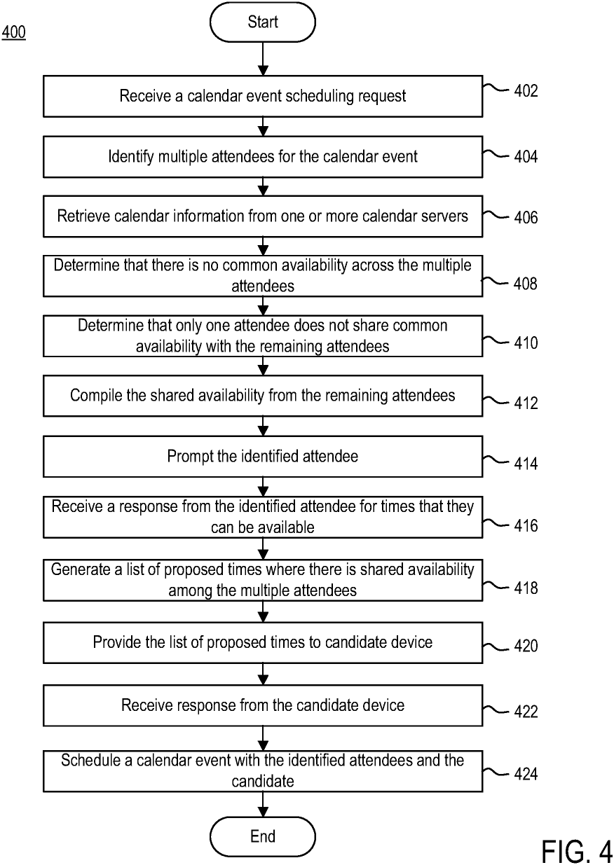

FIG. 4 is a flow diagram illustrating a method 400 of performing a calendar negotiation process, according to example embodiments. Method 400 may begin at step 402.

At step 402, back-end computing system 104 may receive a scheduling request from a client device 102 (e.g., a lead client device 102). In some embodiments, back-end computing system 104 may receive calendar event scheduling request via application 110 executing on client device 102. In some embodiments, back-end computing system 104 may receive a calendar event scheduling request via a message sent to intelligent assistant 116. In some embodiments, the calendar event scheduling request may include one or more parameters associated therewith. For example, the calendar event scheduling request may include one or more of the job opening, the candidate for the calendar event, calendar event duration, attendees (e.g., interviewers), preparation documents, notes, and the like.

At step 404, back-end computing system 104 may identify multiple attendees for the calendar event. In some embodiments, the one or more possible attendees may be specified, by name, in the calendar event request. In some embodiments, one or more possible groups of attendees may be specified in the calendar event request. For example, lead client device 102 may only specify that there should be at least one person from a first group (e.g., sales) and at least one person from a second group (e.g., marketing) in each calendar event time slot. In some embodiments, the attendees are not specified, and scheduling coordinator 120 may default to a predefined list of attendees.

At step 406, back-end computing system 104 may retrieve calendar information from one or more calendar servers 108. For example, scheduling coordinator 120 may interface with one or more calendar servers 108 to pull or retrieve calendar data related to multiple attendees for the calendar event or calendar events with the candidate.

At step 408, back-end computing system 104 may determine that there is no common availability across multiple attendees. For example, scheduling coordinator 120 may compile the calendar information for all of the multiple attendees, and may analyze the compiled calendar information to determine whether there is a common time that works for all parties. If there is a time that works for all parties, scheduling coordinator 120 may schedule the calendar event for that identified time. If, however, there is not a time that works for all parties, scheduling coordinator 120 may initiate a negotiation process to find a common time that does work.

At step 410, back-end computing system 104 may determine that only one attendee does not share a common availability with the remaining attendees. In other words, scheduling coordinator 120 may determine that there is a common time that works for all attendees but one attendee.

At step 412, back-end computing system 104 may compile the shared availability from the other attendees. For example, scheduling coordinator 120 may generate a list that includes dates and times for which the remaining attendees are all available. In this manner, scheduling coordinator 120 may provide the interviewee with a list of dates and times that work for the rest of the group.

At step 414, back-end computing system 104 may prompt the identified attendee. In some embodiments, the prompt may include the compiled list of shared availability from the other attendees. In some embodiments, intelligent assistant 116 may prompt the identified attendee. For example, intelligent assistant 116 may ask the attendee to view the list of shared availability to see what time, if any, works for the identified attendee.

At step 416, back-end computing system 104 may receive a response from the identified attendee for times that they can be available. For example, the identified attendee, via client device 102 may indicate which times, from the compiled list of shared available, works for the identified attendee. In some embodiments, the identified attendee may provide the response, in natural language form, to intelligent assistant 116. Intelligent assistant 116 may utilize one or more natural language processes to interpret the identified attendee’s response.

At step 418, back-end computing system 104 may generate a list of proposed times where there is shared availability among the attendees. For example, scheduling coordinator 120 may generate a list of possible calendar event times to be sent to a candidate for the calendar event.

At step 420, back-end computing system 104 may provide the list of proposed times to candidate device 106. In some embodiments, back-end computing system 104 may provide candidate device 106 with the list of proposed times via application 124 executing on candidate device 106. For example, back-end computing system 104 may push a notification for a candidate to select calendar event times via an interface presented via application 124. In some embodiments, back-end computing system 104 may provide candidate device 106 with the list of proposed times via intelligent assistant 116. For example, intelligent assistant 116 may send a text message to candidate device 106 that includes a listing of proposed times for the candidate to select from.

At step 422, back-end computing system 104 may receive the response from the candidate. For example, the response may indicate which time, of the possible times, the candidate chose for the calendar event. In some embodiments, back-end computing system 104 may receive the response via application 124 executing on candidate device 106 in natural language. In some embodiments, back-end computing system 104 may receive the response via a text message provided to intelligent assistant 116 in natural language. In some embodiments, if, for example, multiple times work for the candidates, scheduling coordinator 120 may use a load-balancing algorithm to determine which interviewer to schedule the interview with. In some embodiments, if, for example, the candidate cannot make one of the times suggested, scheduling coordinator 120 may offer up additional times that meet the inputs via a link to a full calendar of available times.

At step 424, back-end computing system 104 may schedule a calendar event with the identified attendees and the candidate in real-time. In some embodiments, scheduling the calendar event may include pushing a calendar invite to each attendee’s client device 102 and candidate device 106.

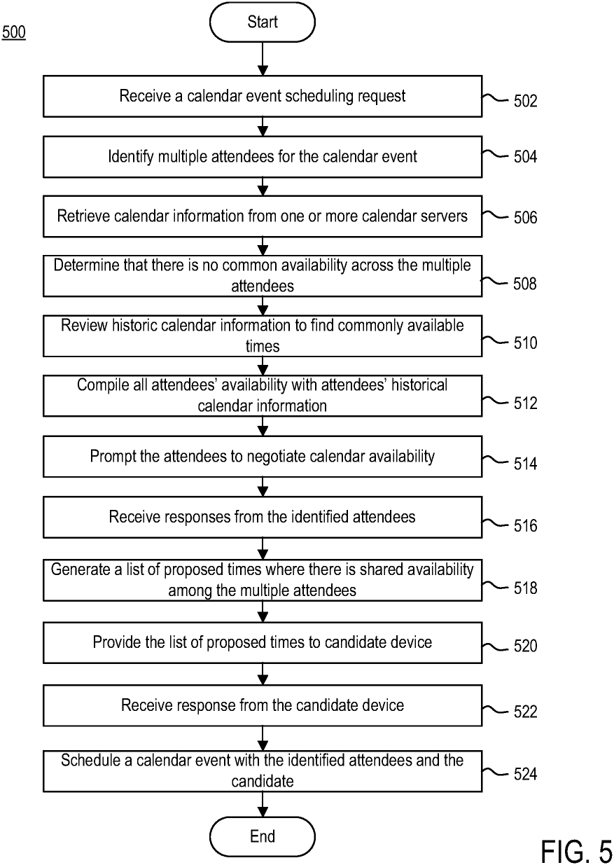

FIG. 5 is a flow diagram illustrating a method 500 of performing a calendar negotiation process, according to example embodiments. Method 500 may begin at step 502.

At step 502, back-end computing system 104 may receive a scheduling request from a client device 102 (e.g., a lead client device 102). In some embodiments, back-end computing system 104 may receive calendar event scheduling request via application 110 executing on client device 102. In some embodiments, back-end computing system 104 may receive a calendar event scheduling request via a message sent to intelligent assistant 116. In some embodiments, the calendar event scheduling request may include one or more parameters associated therewith. For example, the calendar event scheduling request may include one or more of the job opening, the candidate for the calendar event, calendar event duration, attendees (e.g., interviewers), preparation documents, notes, and the like.

At step 504, back-end computing system 104 may identify multiple attendees for the calendar event. In some embodiments, the one or more possible attendees may be specified, by name, in the calendar event request. In some embodiments, one or more possible groups of attendees may be specified in the calendar event request. For example, lead client device 102 may only specify that there should be at least one person from a first group (e.g., sales) and at least one person from a second group (e.g., marketing) in each calendar event time slot. In some embodiments, the attendees are not specified, and scheduling coordinator 120 may default to a predefined list of attendees.

At step 506, back-end computing system 104 may retrieve calendar information from one or more calendar servers 108. For example, scheduling coordinator 120 may interface with one or more calendar servers 108 to pull or retrieve calendar data related to multiple attendees for the calendar event or calendar events with the candidate.

At step 508, back-end computing system 104 may determine that there is no common availability across multiple attendees. For example, scheduling coordinator 120 may compile the calendar information for all of the multiple attendees, and may analyze the compiled calendar information to determine whether there is a common time that works for all parties. If there is a time that works for all parties, scheduling coordinator 120 may schedule the calendar event for that identified time. If, however, there is not a time that works for all parties, scheduling coordinator 120 may initiate a negotiation process to find a common time that does work. In such embodiments, scheduling coordinator 120 may determine that there is not a common time that works for two or more attendees.

At step 510, back-end computing system 104 may review historic calendar data to find commonly available times for the multiple attendees. For example, scheduling coordinator 120 may analyze the retrieved calendar information to learn when the attendees have previously been available as a group. In some embodiments, scheduling coordinator 120 may utilize one or more machine learning techniques to identify when the attendees have previously been available as a group. In this manner, scheduling coordinator 120 may learn and understand what times would work best for the entire group.

At step 512, back-end computing system 104 may compile all attendees' availability with the attendees' historical calendar information. For example, scheduling coordinator 120 may generate a list that includes dates and times for the attendees are available. Scheduling coordinator 120 may supplement this list with the attendees' historical calendar information. In this manner, scheduling coordinator 120 may anticipate dates and times for which the group of attendees are expected to be available at the same time.

At step 514, back-end computing system 104 may prompt the attendees to negotiate calendar availability. In some embodiments, the prompt may include the compiled list of shared availability with anticipated availability. In some embodiments, intelligent assistant 116 may ask the attendees to view the list of shared availability to see what time, if any, works for each attendee.

At step 516, back-end computing system 104 may receive responses from the identified attendee for times that they can be available. For example, each attendee, via their client device 102, may indicate which times, from the compiled list of shared available, works for the attendee. In some embodiments, an attendee may provide the response, in natural language form, to intelligent assistant 116. Intelligent assistant 116 may utilize one or more natural language processes to interpret the attendee’s response.

At step 518, back-end computing system 104 may generate a list of proposed times where there is shared availability among the attendees. For example, scheduling coordinator 120 may generate a list of possible calendar event times to be sent to a candidate for the calendar event.

At step 520, back-end computing system 104 may provide the list of proposed times to candidate device 106. In some embodiments, back-end computing system 104 may provide candidate device 106 with the list of proposed times via application 124 executing on candidate device 106. For example, back-end computing system 104 may push a notification for a candidate to select calendar event times via an interface presented via application 124. In some embodiments, back-end computing system 104 may provide candidate device 106 with the list of proposed times via intelligent assistant 116. For example, intelligent assistant 116 may send a text message to candidate device 106 that includes a listing of proposed times for the candidate to select from.

At step 522, back-end computing system 104 may receive the response from the candidate. For example, the response may indicate which time, of the possible times, the candidate chose for the calendar event. In some embodiments, back-end computing system 104 may receive the response via application 124 executing on candidate device 106 in natural language. In some embodiments, back-end computing system 104 may receive the response via a text message provided to intelligent assistant 116 in natural language.

At step 524, back-end computing system 104 may schedule a calendar event with the identified attendees and the candidate in real-time. In some embodiments, scheduling the calendar event may include pushing a calendar invite to each attendee’s client device 102 and candidate device 106.

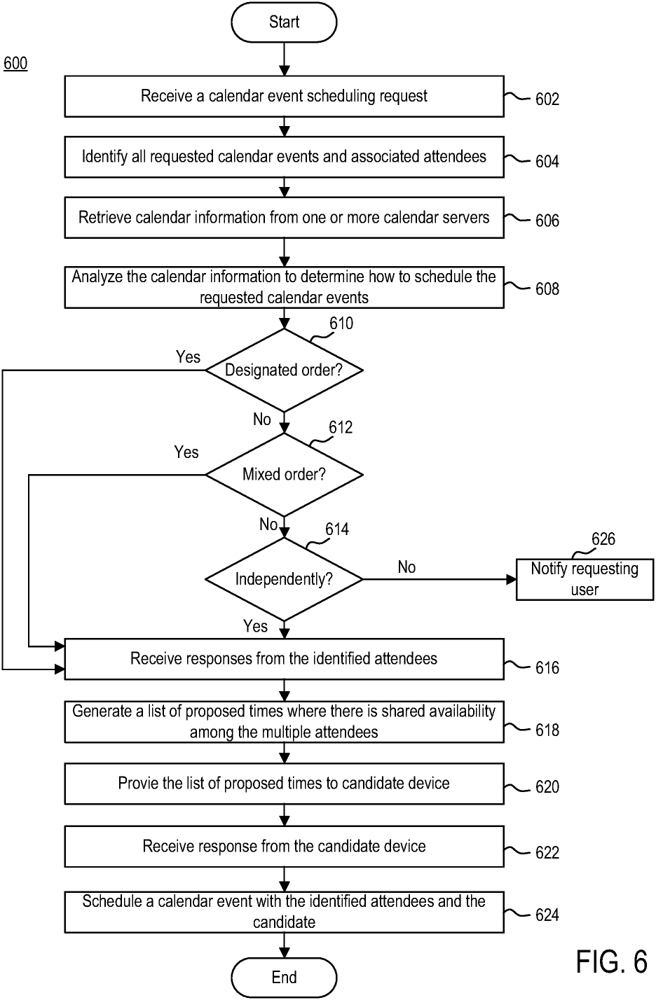

FIG. 6 is a flow diagram illustrating a method 600 of scheduling multiple calendar events, according to example embodiments. Method 600 may begin at step 602.

At step 602, back-end computing system 104 may receive a scheduling request from a client device 102 (e.g., a lead client device 102). In some embodiments, back-end computing system 104 may receive calendar event scheduling request via application 110 executing on client device 102. In some embodiments, back-end computing system 104 may receive a calendar event scheduling request via a message sent to intelligent assistant 116. In some embodiments, the calendar event scheduling request may include one or more parameters associated therewith. For example, the calendar event scheduling request may include one or more of the job opening, the candidate for the calendar event, calendar event duration, attendees (e.g., interviewers), preparation documents, notes, and the like.

At step 604, back-end computing system 104 may identify all requested calendar events and associated attendees. For example, the scheduling request may include a request for multiple calendar events or sessions. Using a more specific example, the scheduling request may be for an interview, in which the candidate will have three interview sessions with three different interviewers. Scheduling coordinator 120 may determine how many sessions are needed and which attendees are required for each session. In some embodiments, scheduling coordinator 120 may identify one or more constraints associated with the scheduling request. For example, the request may indicate a time frame during which the calendar events should be scheduled (e.g., any time within the next two weeks, any time in the afternoon within the next ten days, etc.). In some embodiments, the request may include an ordering of calendar events. For example, the requesting user may indicate that the first calendar event should be scheduled with Person A, the second calendar event should be scheduled with Person B, and the third calendar event should be scheduled with Person C.

At step 606, back-end computing system 104 may retrieve calendar information from one or more calendar servers 108. For example, scheduling coordinator 120 may interface with one or more calendar servers 108 to pull or retrieve calendar data related to the indicated attendees.

At step 608, back-end computing system 104 may analyze the retrieved calendar information to determine how to schedule the calendar events. At step 610, back-end computing system 104 may determine whether the calendar events can be scheduled in the designated order. For example, scheduling coordinator 120 may analyze the retrieved calendar information to determine if there is a day where the multiple calendar events can be scheduled with the indicated attendees in the indicated order. If, at step 610, back-end computing system 104 determines that the calendar events can be scheduled in the designated order, then method 600 proceeds to step 616. If, however, at step 610, back-end computing system 104 determines that the calendar events cannot be scheduled in the designated order, then method 600 proceeds to step 612.

At step 612, back-end computing system 104 may determine whether the calendar events can be scheduled in a mixed order within a single day. For example, scheduling coordinator 120 may analyze the retrieved calendar information to determine if there is a day where the multiple calendar events can be scheduled with the indicated attendees in any order. If, at step 612, back-end computing system 104 determines that the calendar events can be scheduled in a mixed order, then method 600 proceeds to step 616. If, however, at step 612, back-end computing system 104 determines that the calendar events cannot be scheduled in the mixed order, then method 600 proceeds to step 614.

At step 614, back-end computing system 104 may determine whether the calendar events can be scheduled independently. For example, scheduling coordinator 120 may analyze the retrieved calendar information to determine if there are multiple days where the multiple calendar events can be scheduled with the indicated attendees in any order. If, at step 612, back-end computing system 104 determines that the calendar events can be scheduled in any order across multiple days, then method 600 proceeds to step 616. If, however, at step 612, back-end computing system 104 determines that the calendar events cannot be scheduled in any order across multiple days, then method 600 proceeds to step 626. At step 626, back-end computing system 104 may notify the requesting user that the calendar invites are unable to be scheduled.

At step 616, back-end computing system 104 may notify the requesting user of the most appropriate scheduling order. For example, scheduling coordinator 120 may notify the requesting user which scheduling order works best for the scheduling request.

At step 618, back-end computing system 104 may generate a list of proposed times where there is shared availability among the attendees. For example, scheduling coordinator 120 may generate a list of possible calendar event times to be sent to a candidate for the calendar event.

At step 620, back-end computing system 104 may provide the list of proposed times to candidate device 106. In some embodiments, back-end computing system 104 may provide candidate device 106 with the list of proposed times via application 124 executing on candidate device 106. For example, back-end computing system 104 may push a notification for a candidate to select calendar event times via an interface presented via application 124. In some embodiments, back-end computing system 104 may provide candidate device 106 with the list of proposed times via intelligent assistant 116. For example, intelligent assistant 116 may send a text message to candidate device 106 that includes a listing of proposed times for the candidate to select from.

At step 622, back-end computing system 104 may receive the response from the candidate. For example, the response may indicate which time, of the possible times, the candidate chose for the calendar event. In some embodiments, back-end computing system 104 may receive the response via application 124 executing on candidate device 106 in natural language. In some embodiments, back-end computing system 104 may receive the response via a text message provided to intelligent assistant 116 in natural language.

At step 624, back-end computing system 104 may schedule a calendar event with the identified attendees and the candidate in real-time. In some embodiments, scheduling the calendar event may include pushing a calendar invite to each attendee’s client device 102 and candidate device 106.

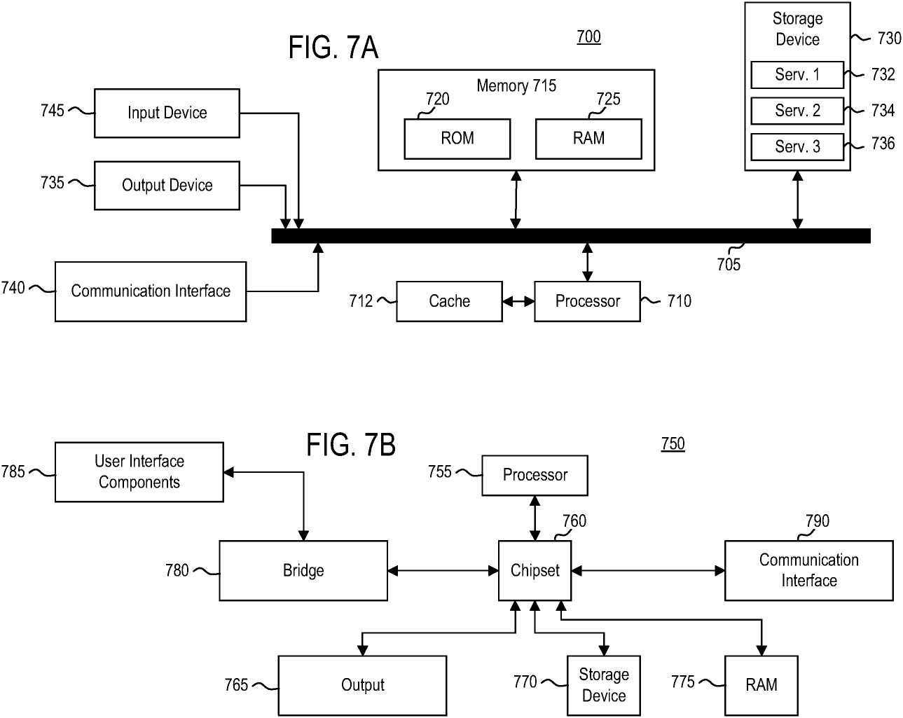

FIG. 7A illustrates an architecture of system bus computing system 700, according to example embodiments. One or more components of system 700 may be in electrical communication with each other using a bus 705. System 700 may include a processor (e.g., one or more CPUs, GPUs or other types of processors) 710 and a system bus 705 that couples various system components including the system memory 715, such as read only memory (ROM) 720 and random access memory (RAM) 725, to processor 710. System 700 can include a cache of high-speed memory connected directly with, in close proximity to, or integrated as part of, processor 710. System 700 can copy data from memory 715 and/or storage device 730 to cache 712 for quick access by processor 710. In this way, cache 712 may provide a performance boost that avoids processor 710 delays while waiting for data. These and other modules can control or be configured to control processor 710 to perform various actions. Other system memory 715 may be available for use as well. Memory 715 may include multiple different types of memory with different performance characteristics. Processor 710 may be representative of a single processor or multiple processors. Processor 710 can include one or more of a general purpose processor or a hardware module or software module, such as service 1 732, service 2 734, and service 7 736 stored in storage device 730, configured to control processor 710, as well as a special-purpose processor where software instructions are incorporated into the actual processor design. Processor 710 may essentially be a completely self-contained computing system, containing multiple cores or processors, a bus, memory controller, cache, etc. A multi-core processor may be symmetric or asymmetric.

To enable user interaction with the system 700, an input device 745 can be any number of input mechanisms, such as a microphone for speech, a touch-sensitive screen for gesture or graphical input, keyboard, mouse, motion input, speech and so forth. An output device 735 (e.g., a display) can also be one or more of a number of output mechanisms known to those of skill in the art. In some instances, multimodal systems can enable a user to provide multiple types of input to communicate with system 700. Communication interface 740 can generally govern and manage the user input and system output. There is no restriction on operating on any particular hardware arrangement, and therefore the basic features here may easily be substituted for improved hardware or firmware arrangements as they are developed.

Storage device 730 may be a non-volatile memory and can be a hard disk or other type of computer readable media that can store data that are accessible by a computer, such as magnetic cassettes, flash memory cards, solid state memory devices, digital versatile disks, cartridges, random access memories (RAMs) 725, read only memory (ROM) 720, and hybrids thereof.

Storage device 730 can include services 732, 734, and 736 for controlling the processor 710. Other hardware or software modules are contemplated. Storage device 730 can be connected to system bus 705. In one aspect, a hardware module that performs a particular function can include the software component stored in a computer-readable medium in connection with the necessary hardware components, such as processor 710, bus 705, output device 735 (e.g., a display), and so forth, to carry out the function.

FIG. 7B illustrates a computer system 750 having a chipset architecture, according to example embodiments. Computer system 750 may be an example of computer hardware, software, and firmware that can be used to implement the disclosed technology. System 750 can include one or more processors 755, representative of any number of physically and/or logically distinct resources capable of executing software, firmware, and hardware configured to perform identified computations. One or more processors 755 can communicate with a chipset 760 that can control input to and output from one or more processors 755. In this example, chipset 760 outputs information to output 765, such as a display, and can read and write information to storage device 770, which can include magnetic media, and solid-state media, for example. Chipset 760 can also read data from and write data to RAM 775. A bridge 780 for interfacing with a variety of user interface components 785 can be provided for interfacing with chipset 760. Such user interface components 785 can include a keyboard, a microphone, touch detection and processing circuitry, a pointing device, such as a mouse, and so on. In general, inputs to system 750 can come from any of a variety of sources, machine generated and/or human generated.

Chipset 760 can also interface with one or more communication interfaces 790 that can have different physical interfaces. Such communication interfaces can include interfaces for wired and wireless local area networks, for broadband wireless networks, as well as personal area networks. Some applications of the methods for generating, displaying, and using the GUI disclosed herein can include receiving ordered datasets over the physical interface or be generated by the machine itself by one or more processors 755 analyzing data stored in storage device 770 or RAM 775. Further, the machine can receive inputs from a user through user interface components 785 and execute appropriate functions, such as browsing functions by interpreting these inputs using one or more processors 755.

It can be appreciated that example systems 700 and 750 can have more than one processor 710, 755 or be part of a group or cluster of computing devices networked together to provide greater processing capability.

While the foregoing is directed to embodiments described herein, other and further embodiments may be devised without departing from the basic scope thereof. For example, aspects of the present disclosure may be implemented in hardware or software or a combination of hardware and software. One embodiment described herein may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory (ROM) devices within a computer, such as CD-ROM disks readable by a CD-ROM drive, flash memory, ROM chips, or any type of solid-state non-volatile memory) on which information is permanently stored; and (ii) writable storage media (e.g., floppy disks within a diskette drive or hard-disk drive or any type of solid state random-access memory) on which alterable information is stored. Such computer-readable storage media, when carrying computer-readable instructions that direct the functions of the disclosed embodiments, are embodiments of the present disclosure.

It will be appreciated to those skilled in the art that the preceding examples are exemplary and not limiting. It is intended that all permutations, enhancements, equivalents, and improvements thereto are apparent to those skilled in the art upon a reading of the specification and a study of the drawings are included within the true spirit and scope of the present disclosure. It is therefore intended that the following appended claims include all such modifications, permutations, and equivalents as fall within the true spirit and scope of these teachings.

1. A method, comprising:
receiving, by an intelligent assistant of a computing system, a first message from a first client device, the first message comprising a request to schedule a calendar event with a target user;
identifying, by the computing system, possible attendees for the calendar event based on the request;
interfacing, by the computing system, with calendar servers associated with electronic calendars associated with the possible attendees to retrieve calendar information for each possible attendee;
analyzing, by the computing system, the calendar information for each possible attendee to identify a plurality of possible time slots for the calendar event;
prompting, by the computing system, the target user to select a time slot from the plurality of possible time slots by sending the target user a message comprising the plurality of possible time slots;
receiving, by the computing system, a selection of the time slot from the plurality of possible time slots from the target user via a reply message sent from the target user to the intelligent assistant of the computing system;
identifying, by the computing system, a subset of possible attendees associated with the time slot; and
based on the receiving and identifying, scheduling, by the computing system, in real-time, the calendar event comprising the target user and the subset of possible attendees.

2. The method of claim 1, wherein analyzing, by the computing system, the calendar information for each possible attendee to identify the plurality of possible time slots for the calendar event comprises:
generating an aggregated calendar by aggregating calendar information for each possible attendee in a single calendar.

3. The method of claim 1, wherein analyzing, by the computing system, the calendar information for each possible attendee to identify the plurality of possible time slots for the calendar event comprises:
determining that there is not a threshold number of possible time slots for the calendar event; and
based on the determining, prompting each possible attendee to create more space in their associated electronic calendar.

4. The method of claim 1, wherein the request comprises a specification that the calendar event comprises a first attendee from a first group of possible attendees and a second attendee from a second group of possible attendees.

5. The method of claim 4, wherein analyzing, by the computing system, the calendar information for each possible attendee to identify the plurality of possible time slots for the calendar event comprises:
identifying overlapping time slots, wherein each overlapping time slot comprises a first available attendee from the first group of possible attendees and a second available attendee from the second group of possible attendees.

6. The method of claim 1, further comprising:
receiving, by the computing system via the intelligent assistant, a rescheduling request message from the target user in natural language; and
based on the rescheduling request message, re-analyzing, by the computing system, the calendar information for each possible attendee to identify a new plurality of possible time slots for the calendar event.

7. The method of claim 1, further comprising:
periodically pushing, by the computing system via the intelligent assistant, reminders to the target user.

8. A method, comprising:
receiving, by an intelligent assistant of a computing system, a first message from a first client device, the first message comprising a request to schedule a calendar event with a candidate;
identifying, by the computing system, multiple attendees for the calendar event based on the request;
interfacing, by the computing system, with calendar servers associated with electronic calendars associated with the multiple attendees to retrieve calendar information for each attendee;
determining, by the computing system, that there is no common availability among the multiple attendees based on the calendar information;
determining, by the computing system, that a single attendee does not have common availability with remaining attendees of the multiple attendees;
compiling, by the computing system, shared availability among the remaining attendees into a list;
prompting, by the computing system, the single attendee to select a time from the list by sending the single attendee a message comprising the shared availability;
receiving, by the computing system, a selection of a time for the calendar event from the list a reply message sent from the single attendee to the intelligent assistant of the computing system; and
based on the selection, scheduling, by the computing system, in real-time, the calendar event for the selected time, the calendar event comprising the multiple attendees and the candidate.

9. The method of claim 8, wherein determining, by the computing system, that there is no common availability among the multiple attendees based on the calendar information comprises:
generating an aggregated calendar by aggregating the calendar information for each attendee of the multiple attendees in a single calendar.

10. The method of claim 8, further comprising:
receiving, by the computing system via the intelligent assistant, a rescheduling request message from an attendee of the multiple attendees in natural language; and
based on the rescheduling request message, re-analyzing, by the computing system, the calendar information for each possible attendee to identify a new time for the calendar event.

11. The method of claim 8, further comprising:
periodically pushing, by the computing system via the intelligent assistant, reminders to the candidate.

12. The method of claim 8, further comprising:
interfacing, by the computing system, with a video conference application to generate a video conference link for the calendar event.

13. The method of claim 8, further comprising:
responsive to the selection of the time, providing, by the computing system, the time for the calendar event to the candidate.

14. The method of claim 13, further comprising:
receiving, by the computing system, an indication from the candidate that the time for the calendar event is approved.

15. A method, comprising:
receiving, by an intelligent assistant of a computing system, a first message from a first client device, the first message comprising a request to schedule a calendar event with a candidate;
identifying, by the computing system, multiple attendees for the calendar event based on the request;
interfacing, by the computing system, with calendar servers associated with electronic calendars associated with the multiple attendees to retrieve calendar information for each attendee;
determining, by the computing system, that there is no common availability among the multiple attendees based on the calendar information;
based on the determining, reviewing, by the computing system, historic calendar information associated with the multiple attendees to learn when the multiple attendees have been previously available as a group;
compiling, by the computing system, available times of the multiple attendees with the historic calendar information;
prompting, by the computing system, the multiple attendees to select a set of times from the available times of the multiple attendees;
receiving, by the computing system, a plurality of responses from the multiple attendees;
analyzing, by the computing system, the plurality of responses to identify an available time that is common among the multiple attendees;
based on the analyzing, scheduling, by the computing system, in real-time, the calendar event for the available time, the calendar event comprising the multiple attendees and the candidate.

16. The method of claim 15, wherein determining, by the computing system, that there is not common availability among the multiple attendees based on the calendar information comprises:
generating an aggregated calendar by aggregating the calendar information for each attendee of the multiple attendees in a single calendar.

17. The method of claim 15, further comprising:
receiving, by the computing system via the intelligent assistant, a rescheduling request message from an attendee of the multiple attendees in natural language; and
based on the rescheduling request message, re-analyzing, by the computing system, the calendar information for each possible attendee to identify a new time for the calendar event.

18. The method of claim 15, further comprising:
periodically pushing, by the computing system via the intelligent assistant, reminders to the candidate.

19. The method of claim 15, further comprising:
interfacing, by the computing system, with a video conference application to generate a video conference link for the calendar event.

20. The method of claim 15, further comprising:
notifying, by the computing system, each attendee of the multiple attendees of the calendar event for the available time.
